(19) United States
(12) Patent Application Publication
(10) Pub. No.: US 2019/0330079 A1
(43) Pub. Date: Oct. 31, 2019

(54) WATER DISTILLATION SYSTEM AND METHOD OF DISTILLING WATER

(71) Applicant: BIOTURBINE SYSTEMS INC., Ville Saint-Laurent (CA)

(72) Inventor: Paul MAYRAND, Ville Saint-Laurent (CA)

(21) Appl. No.: 16/311,548

(22) PCT Filed: Jul. 11, 2017
(86) PCT No.: PCT/CA2017/050844

§ 371 Date: Dec. 19, 2018

Related U.S. Application Data
(60) Provisional application No. 62/361,205, filed on Jul. 12, 2016.

(51) Int. Cl. C02F 1/10; B01D 3/34; B01D 3/16

(52) U.S. Cl. CPC C02F 1/10; B01D 5/0003; B01D 3/16; B01D 3/346

(57) ABSTRACT

A distillation system has an evaporator that uses heated air circulating in water to transport water laden air to a cooling apparatus. The cooling apparatus condenses the water present in the water laden air to produce distilled water, which is free of the biological matter and minerals that may have been present in the water present in the evaporator. The apparatus can include an airlift pump. A method of distilling water comprises the steps of generating an airflow; heating the airflow to obtain a heated airflow; providing the heated airflow to the water to heat the water and to produce water saturated air; and cooling the water saturated air to obtained distilled water.

### FIELD

The present disclosure relates generally to water purification. More particularly, the present disclosure relates to water distillation systems and methods of distilling water.

### BACKGROUND

Water management remains important, especially in water-scarce regions of the world, such as, for example, the Sun Belt in the U.S.A. In such regions, water taxes are usually high and, as such, there is a strong incentive to conserve and recover water.

Progress in the ability of treating and recovering wastewater such as domestic wastewater is taking place. However, the systems and cost associated with making the recovered water safe for drinking remain prohibitive.

Therefore, improvements in processing recovered water into drinkable water are desirable.

### BRIEF DESCRIPTION OF THE DRAWINGS

Embodiments of the present disclosure will now be described, by way of example only, with reference to the attached Figures.

FIG. 1 shows an embodiment of water distillation system in accordance with the present disclosure.

FIG. 2 shows a side elevation view of some components of another embodiment of the distillation system of the present disclosure.

FIG. 3 shows a top view of the components of FIG. 2.

FIG. 4 shows another embodiment of a distillation system in accordance with the present disclosure.

FIG. 5 shows yet another embodiment of a distillation system in accordance with the present disclosure.

FIG. 6 shows a further embodiment of a distillation system in accordance with the present disclosure.

FIG. 7 shows a cutaway view of an embodiment of an evaporator apparatus in accordance with the present disclosure.

FIG. 8 shows a flow chart of a method of distilling water in accordance with an embodiment of the present disclosure.

FIG. 9 shows a flow chart of another method of distilling water in accordance with an embodiment of the present disclosure.

### SUMMARY OF THE INVENTION

In a first aspect, the present disclosure provides a water distillation system that comprises: a heating chamber defining an air inlet configured to receive air in the heating chamber, the heating chamber further defining an air outlet configured to release air from the heating chamber. The system further comprises a heater located in the heating chamber, the heater configured to heat the air propagating in the heating chamber from the air inlet to the air outlet, the air released by the air outlet being heated air. Furthermore, the system comprises a riser defining a water input portion configured to receive water in the riser, the riser being configured to receive the heated air in a region of the riser configured to contain water, the heated air, when water is present in the riser, to produce air bubbles in the riser, the air bubbles to absorb water to obtain water saturated air bubbles, the water saturated air bubbles to rise in the riser and to exit the water present in the riser, the riser further defining a water saturated air output portion configured to receive the water saturated air and to propagate the water saturated air to an outside of the riser.

In some embodiments of the system, the heating chamber is formed outside the riser, the air outlet comprises an air conduit connected to the heating chamber and to the air input portion of the riser, and the air conduit is configured to release the heated air into the riser.

In some embodiments of the system, the heating chamber can be formed at least partly within the riser. In such embodiments, the air outlet can include a series of apertures configured to transmit the heated air from the heating chamber to any water present in the riser.

In some embodiments the system further comprises a pump configured for connection to the air inlet of the heating chamber, the pump to provide the air, or any other suitable gas, to the heating chamber.

In some embodiments, the system further comprises a water container to receive the water to be distilled, wherein: the heating chamber is located in the water container and the water input portion of the riser is in fluid communication with the water container.

In some embodiments, the system further comprises a heating device configured to heat any water that may present in the water container.

In some embodiments of the system, the heating device is configured to heat the water in the water container to a temperature of up to the boiling temperature of water.

In some embodiments of the system, the heater is configured to heat the air entering the air inlet to a temperature greater than 100° C.

In some embodiments, the system further comprises a cooling apparatus configured to receive the water saturated air from the water saturated air output portion of the riser and to cool the water saturated air, and the cooling apparatus is further configured to condense the water present in the water saturated air to produce distilled water.

In some embodiments, the system further comprises a water tank connected to the water container, the water tank to supply the water to the water container.

In some of the embodiments of the system, the cooling apparatus has a water saturated air conduit formed at least partly in the water tank, the water saturated air conduit being configured to transfer heat from the water saturated air present in the water saturated air conduit to the water present in the water tank.

In some of the embodiments of the system, the water saturated air conduit is also partly formed outside the water tank, and a portion of the water saturated air conduit formed outside the water tank is downstream from a portion of the water saturated air conduit formed in the water tank.

In some of the embodiments, the system further comprises an overflow conduit in fluid communication with the water container, the overflow conduit being configured to release water from the water container when a water level in the water container exceeds a pre-determined water level.

In another aspect of the disclosure, there is provided a method of distilling water. The method comprises: generating an airflow; heating the airflow to obtain a heated airflow; providing the heated airflow to the water to heat the water and to produce water saturated air; and cooling the water saturated air to obtained distilled water.

In some embodiments of the method, providing the heated airflow to the water includes providing the heated airflow at a bottom portion of a riser containing the water, and the method further comprises releasing the water saturated air at a top portion of the riser.

In some embodiments of the method, cooling the water saturated air includes providing the water saturated air to a cooling apparatus and cooling the water saturated air to produce distilled water.

In some embodiments of the method, cooling the water saturated air includes transferring heat from the water saturated air to a body of water to heat the body of water prior to the body of water being subjected to a distillation process.

Is some embodiments, the method further comprises pre-heating the water prior to providing the heated airflow to the water.

In another aspect of the disclosure, there is provided a water distillation system that comprises: a vessel configured to hold water; an airlift pump having an air source and a riser tube, the riser tube having a water intake portion configured to be disposed in the vessel and immersed in water when the water distillation system is in operation, the air source configured to provide an airflow to the riser tube at a portion of the riser tube immersed in water when the water distillation system is in operation; and a heater configured to heat the airflow to obtain a heated airflow, the heater to heat the airflow prior to the airflow being provided to the riser tube, the heated airflow to heat the water to produce water saturated air, the riser tube further defining a water saturated air output portion configured to receive the water saturated air and to propagate the water saturated air to an outside of the riser.

In some embodiments, the system further comprises a heating chamber to house the heater, the heating chamber defining an air inlet configured to receive air in the heating chamber, the heating chamber further defining an air outlet configured to release air from the heating chamber, wherein: the heating chamber is formed outside the riser tube, the air outlet comprises an air conduit connected to the heating chamber and to the air input portion of the riser, and the air conduit is configured to release the heated air into the riser tube.

In some embodiments of the system, the heating chamber is formed at least partly within the riser.

In some embodiments of the system, the air outlet includes a series of apertures configured to transmit the heated air from the heating chamber to any water present in the riser tube.

In some embodiments, the system further comprises a pump configured for connection to the air inlet of the heating chamber, the pump to provide the air to the heating chamber.

In some embodiments, the system further comprises a water container to receive the water to be distilled, wherein: the heating chamber is located in the water container and the water input portion of the riser is in fluid communication with the water container.

In some embodiments, the system further comprises a heating device configured to heat any water that may be present in the water container.

In some embodiments of the system, the heating device is configured to heat the water in the water container to a temperature of up to the boiling temperature of water.

In some embodiments of the system, the heater is configured to heat the air entering the air inlet to a temperature ranging from 500° C. to 600° C.

In some embodiments of the system, the system further comprises a cooling apparatus configured to receive the water saturated air from the water saturated air output portion of the riser and to cool the water saturated air, and the cooling apparatus is further configured to condense the water present in the water saturated air to produce distilled water.

In some embodiments the system further comprises a water tank connected to the water container, the water tank to supply the water to the water container.

In some embodiments of the system, the cooling apparatus has a water saturated air conduit formed at least partly in the water tank, the water saturated air conduit being configured to transfer heat from the water saturated air present in the water saturated air conduit to the water present in the water tank.

In some embodiments of the system, the water saturated air conduit is also partly formed outside the water tank, and a portion of the water saturated air conduit formed outside the water tank is downstream from a portion of the water saturated air conduit formed in the water tank.

In some embodiments, the system further comprises an overflow conduit in fluid communication with the water container, the overflow conduit being configured to release water from the water container when a water level in the water container exceeds a pre-determined water level.

Other aspects and features of the present disclosure will become apparent to those ordinarily skilled in the art upon reviewing the following description of specific embodiments in conjunction with the accompanying figures.

### DETAILED DESCRIPTION

The present disclosure relates to the transport of water by air and provides a water distillation system and a method of distilling water. The system of the present disclosure generates a flow of hot air that contains water vapor at a high temperature. The hot air can be water saturated, which means that the relative humidity of the air is at 100%; or, the hot air can have a relative humidity less than 100%. When the relative humidity of the air is at 100%, the air can be referred to as water saturated air or as humid air or water laden air. When the relative humidity of the air is less than 100%, the air can be referred to as humid air or water laden air. The temperature of the hot air can be in the range of, for example, 200° C. to 500° C. The system of the present disclosure provides the water saturated air or the water laden air to a cooling apparatus, which is part of the distillation system. The cooling apparatus reduces the temperature of the humid air and condenses the water present in the water saturated air or the water laden air. The distilled water can meet all the criteria to be classified as drinking water.

As an example, having water saturated air at 300° C. allows for over 46 kg/m³ of water to saturate the air (compared to 17.3 g/m³ at 20° C.). Condensing the saturated air, at a rate of 17 liters/minute (or one m³ per hour) can produce 46 liters of purified water per hour (or more). Condensing humid air that has 50% relative humidity allows 23 kg/m³ of water to be present in the air. Condensing this humid air (air with 50% relative humidity) at a rate of 8.5 liters/minute (or 0.5 m³ per hour) can produce 23 liters of purified (distilled) water per hour.

FIG. 1 shows a side cutaway view of embodiment of water distillation system 20 in accordance with the present disclosure. The water distillation system 20 includes an evaporator apparatus 21 and a cooling apparatus 15, which, in this embodiment, is shown as comprising a condenser apparatus 23 and a conduit 17 connected to the condenser apparatus 23. The condenser apparatus 23 is used to condense water present in the water saturated air or water laden air that arrives at the condenser apparatus 23. The condenser apparatus 23 can include a liquid cooled and/or and air cooled conduit through which the water saturated air or water laden air circulates. The conduit 17 itself can be liquid cooled and/or air cooled and be used to transfer heat from the inside of the conduit 17 to the outside thereof (i.e. to a liquid and/or air). As such, the conduit 17, when used to transfer heat from the water saturated air or water laden air circulating therein to the outside of the conduit 17 is a condenser in itself (or part of a condenser). The evaporator apparatus 21 includes a conduit 19 connected to an air source 42, a heater 24, a heating chamber 26, an air outlet 28, a riser 30 (can also be referred to as a riser conduit or riser tube), a water saturated air output portion 32 (air and water vapor can be referred to as water saturated air when the relative humidity of the air is 100%; when the relative humidity of the air is less than 100%, the air can be referred to as water laden air) and an overflow 34 (can also be referred to as a water overflow). For example, the heater 24 can be an electrical heating element or a natural gas heating element or any other suitable type of heating element. The water saturated air output portion 32 is to be understood as meaning that water saturated air can be output from the riser 30 through “the portion” 32. However, any water rich air (air that does not have 100% relative humidity) can also be output from the riser 30 from the “portion 32”.

The evaporator apparatus 21 also comprises a water container 45, which is shown as holding water 36 to a level indicated by the waterline 38. The water 36 can be any suitable type of water needing to be treated to remove contaminants/minerals and/or in order to become drinking water. For example, the water 36 can be sea water, ground water, wastewater, etc. A conduit 40 provides the water 36 from any suitable source such as, for example, a water tank 47. The water 36 in the water container 45 can be at a temperature of up to the boiling point of water (e.g., 100° C.). The water 36 can be heated prior to entering the water container 45 or can be heated in the water container 45. Alternatively, the water 36 can be heated to a desired temperature (for example, at a temperature comprised between 50° C. and 60° C.) prior to entering the water container 45 and, as will be discussed below, can be further heated in the water container 45. The heating of water in the water tank 47 can be effected through any suitable means such as, amongst others, electrical heating elements (powered in any suitable way; e.g. by using electricity generated by solar cells), or a solar thermal system.

The heating chamber 26 defines an air inlet 22 that is connected to the air source 42 by the conduit 19. The air source 42 can be an air pump or a compressed gas source connected to provide the air and/or gas. The air/gas can be at any suitable temperature, for example, 20° C. The air inlet 22 is configured to receive the air into the heating chamber. The heating chamber 26 also defines an air outlet 28. In this example, the air outlet 28 is shows as being a conduit/pipe/tube. The air is heated by the heater 24 as the air propagates from in air inlet 22 to the air outlet 28, in the heating chamber 24 and along the heater 24. The heated air can be at any suitable temperature, such as at a temperature ranging from 200° C. to 600° C. The air subsequently reaches the air outlet 28, which guides/releases the heated air to the riser 30. At this point, the air can be at a temperature over 400° C.

The riser 30 defines a water input portion 44 (an opening), through which some of the water 36 enters and partially fills the riser 30. When the heated air coming from the air outlet 28 enters the riser 30, the heated air mixes with the water present in the riser 30 and produces air bubbles. As the bubbles form in the riser 30 and as they rise in the riser 30, the air in bubbles absorbs water from their immediate surroundings and the relative humidity of the air in the bubbles increases (it can increase up to saturation, i.e. to a level of 100% relative humidity). When the bubbles leave the water, the contents of the bubbles (air and water vapor) is released in the top portion of the riser 30 and subsequently makes its way to the water saturated air output portion 32 from where it is guided toward the outside of the evaporator apparatus 21. For example, the water saturated air (or water laden air if the air is not saturated with water) can be guided, to the cooling apparatus 15, which comprises the conduit 17 and the condenser apparatus 23, where the water present in the water saturated air condenses into what is now condensed water (distilled water).

Applicant believes that as bubbles form and rise in the riser 30, the water molecules that are at the periphery of the bubbles and that have the highest kinetic energy are the ones that are first absorbed in the bubbles. As such, the water loses some of its highest energy molecules and the temperature (the average temperature) of the water decreases. Additionally, as the bubbles rise in the riser and leave the water, water from the water container 45 enters the riser 30 to compensate for the water that is released from the bubbles. Further, as the water saturated or water laden air is releases from the water, the temperature of the water saturated or water laden air decreases rapidly and water condensation can be observed at temperatures of several hundreds of degrees 200° C. or more (but at a temperature lower than that of the air entering the riser).

As air mixes with water in the riser 30, the average density of the water in the riser 30 is reduced, which leads to a level of water in the riser 30 that is higher than the waterline 38. The overflow 34, which is an opening defined by the riser 30, reduces the risk of the level of water in the riser 30 becoming too high and perhaps reaching the cooling apparatus 15 by entering the water saturated air output portion 32. When the level of water in the riser 30 reaches the overflow, it water out of the riser 30 and back into the water container 45.

As will be understood by the skilled worker, a water pump (not shown) can be used to pump water from the water tank 47 to the water container 45.

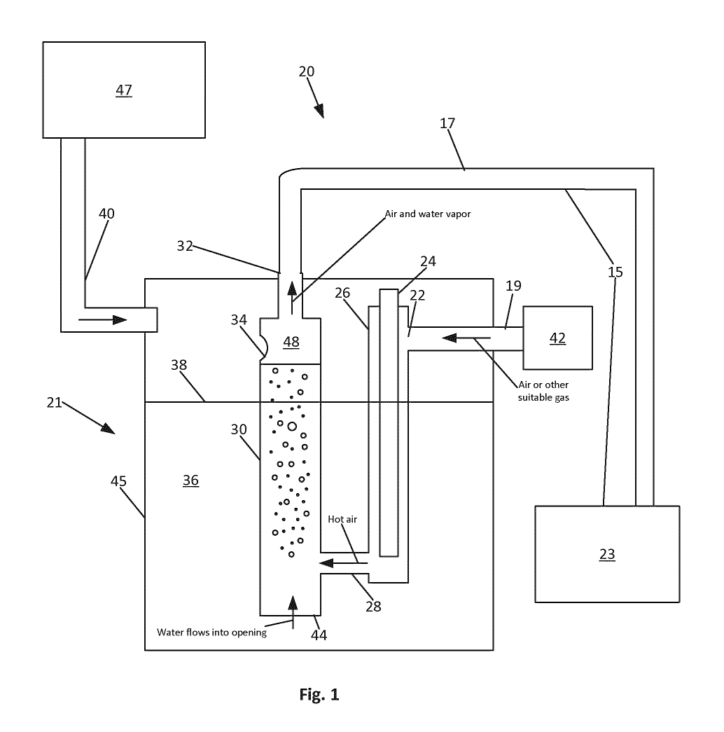

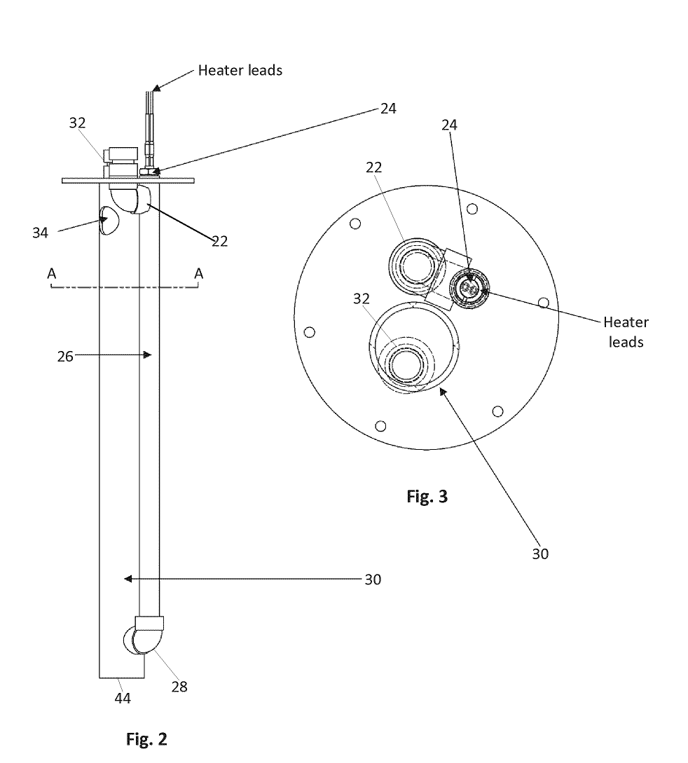

FIG. 2 shows a side elevation view of some components of an embodiment of the evaporator apparatus 21. Shown in FIG. 2 are the heater 24 (which, in this embodiment, is an electrical cartridge heater with heater leads), the air inlet 22, the water saturated air output portion 32 (water saturated air outlet), the overflow 34, the heating chamber 26, the riser 30, the air outlet 28, and the water input portion 44. FIG. 3 shows a cutaway bottom view of the components of FIG. 2, taken along the line A-A of FIG. 2.

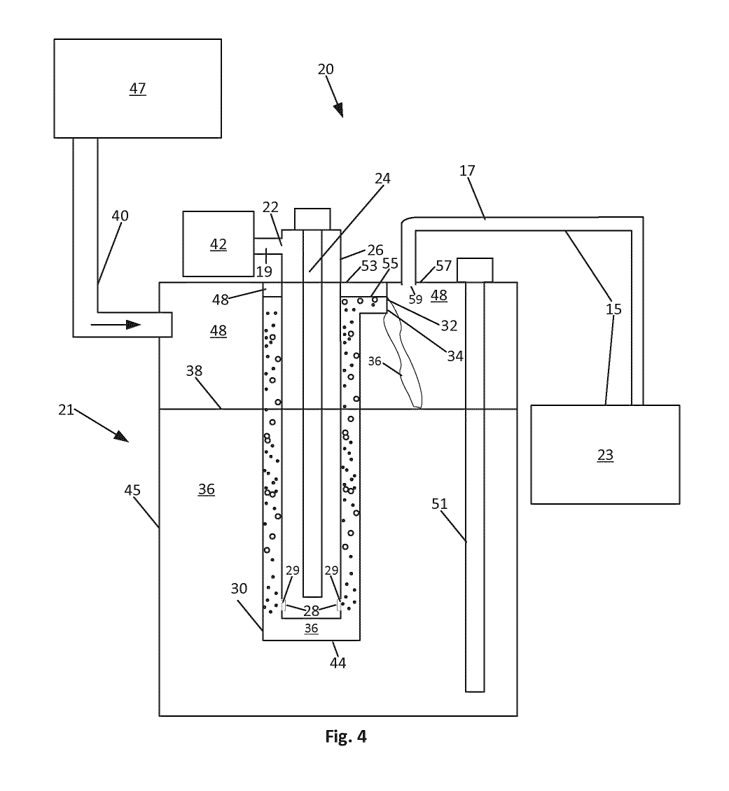

FIG. 4 shows a side cutaway view of another embodiment of a water distillation system 20 in accordance with the present disclosure. As in the embodiment shown at FIG. 1, the water distillation system 20 shown at FIG. 4 includes an evaporator apparatus 21, a cooling apparatus 15 that includes a condenser apparatus 23 and a conduit 17, and a water tank 47. The water tank 47 receives the water to be distilled, at its own water inlet (not shown), from a water source such as, for example, a wastewater system.

In the embodiment of FIG. 4, the air source 42 provides, through the conduit 19, air to the air inlet 22 defined by the heating chamber 26. The air received at the air inlet conduit 22 propagates in the heating chamber 26, along the heater 24, and is released from the heating chamber 26, through the air outlet 28, to the water 36 present in the riser 30. In this embodiment, the air outlet 28 is a series of apertures 29 defined by the heating chamber 26. The dimension of the aperture is chosen to generate a flow of small bubbles in the water 36 present in the riser 30. For example, for circular apertures, the diameter can be about 0.09 inch (about 2.3 mm). In some embodiments, the total area of the apertures can be equal to the area of the air inlet 22.

The configuration of the riser 30 and of the heating chamber 26 is such that any air released out of the air outlet 28 is immediately received at a portion of the riser 30 that contains water 36 when the evaporator apparatus 21 is in operation.

As heated air mixes with water in the riser 30, the average density of the water in the riser 30 is reduced, which leads to a level of water in the riser 30 that is higher than the waterline 38. As in embodiment of FIG. 1, when the bubbles form in the riser 30 and as they rise in the riser 30, the air in bubbles absorbs water from their immediate surroundings and the relative humidity of the air in the bubbles increases (it can increase up to saturation, i.e. to a level of 100% relative humidity). When the bubbles leave the water, the contents of the bubbles (air and water vapor) is released in the top portion of the riser 30 and subsequently makes its way to the outside of the riser 30 and to the water saturated air output portion 32 from where it is guided toward the outside of the evaporator apparatus 21.

The overflow 34, which is an opening defined by the riser 30, allows the water reaching the level of the overflow 34 to fall back into the water container 45. In the embodiment shown at FIG. 4, the water level 55 in the riser 30 is shown as being near the top 53 of the riser 30 and falling back into the water container 45.

The heated air produces water saturated air 48 (or water laden air if the relative humidity in the air present in the bubbles is lower than 100%) which exits the riser 30 through the water saturated air output portion 32 of the riser 30. In this embodiment, the water saturated air output portion 32 also serves as the overflow 34. The water saturated air 48 (or water laden air) then occupies the space between the waterline 38 and the top 57 of the water container 45. Subsequently, the water saturated air 48 enters the conduit 17 at an opening 59 of the conduit 17 and propagates toward the condenser apparatus 23. The water saturated air 48 cools as it propagates through the conduit 17 and when present in the condenser apparatus 23. The cooling is such that water present in the water saturated air 48 condenses into distilled water.

Further, in the embodiment of FIG. 4, a heating device 51 is shown. The heating device 51 can be activated to heat the water 36 to a temperature up to the boiling temperature of the water 36. Advantageously, this allows the heated air exiting the air outlet 28 to produce water saturated air 48 at a higher temperature than if the heating device 51 was absent and the temperature of the water 36 was substantially lower (for example, at a room temperature of 25° C.) than the boiling temperature of the water 36. Further, the load on the heating device 51 is reduced when the water provided to the water container 45 is pre-heated (e.g., at any temperature higher than the temperature of the water would be if no pre-heating of the water was effected; such a temperature can be, for example, comprised between 50° C. and 60° C.) prior to being provided to the water container 45. The heating device 51 can be an electrical heating element or a natural gas heating element or any other suitable type of heating element.

As stated above, Applicant believes that as bubbles form and rise in the riser 30, the water molecules that are at the periphery of the bubbles and that have the highest kinetic energy are the ones that will first be absorbed in the bubbles. As will be understood by the skilled worker, the warmer the water in the riser 30 the more water molecules at the periphery of the bubbles will have sufficient energy to be absorbed by the bubbles and the more water can be transferred to the bubbles. Further, the warmer the water in the riser 30 the less energy transfer there is from the air bubbles to the water. Therefore, it is advantageous to have the water in the water container 45 heated, up to the boiling temperature of the water in order to transfer as little energy as possible from the air bubbles to the water and in order to have as many water molecules with high enough kinetic energy to be absorbed in the air bubbles.

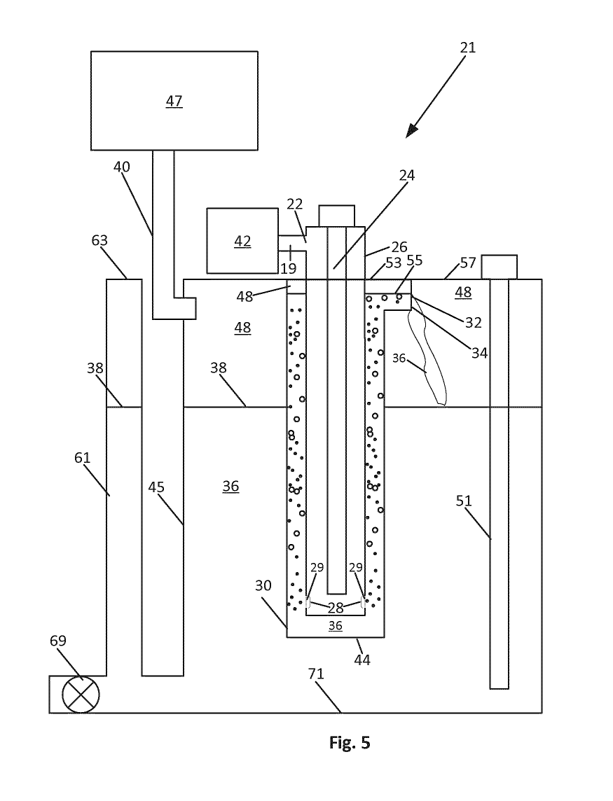

FIG. 5 shows a side cutaway view of another embodiment of an evaporator apparatus 21 in accordance with the present disclosure (in this figure, the cooling apparatus is no shown to avoid overcrowding the figure). The evaporator apparatus 21 shown in FIG. 2 is the same as the one shown in FIG. 4 except that the evaporator apparatus 21 of FIG. 5 has a water container overflow 61 in fluid communication with the water container 45. In this embodiment, and in a scenario where water level in the water container 45 were to increase at a greater rate than that it can be distilled, the water container 45 would continue filing up to point where the waterline would reach the top 53 of the water container 45. Beyond that, any additional water provided to the water container 45 by the water tank 47 would spill out of the evaporator apparatus 21 through the opening 63 of the water container overflow 61.

Further, the embodiment of FIG. 5 has a valve 69 that can be open to flush out the evaporator apparatus 21 from any accumulation of solids at the bottom 71 of the water container 45.

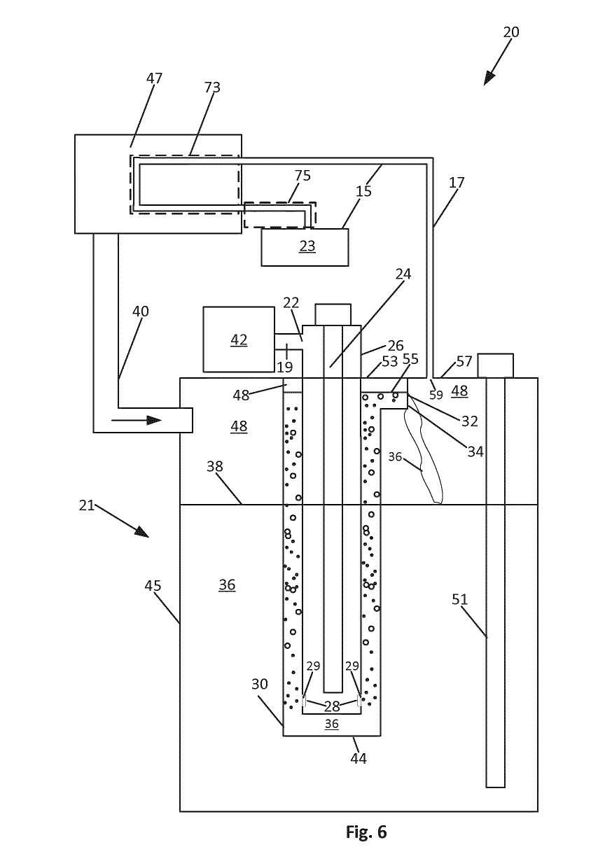

FIG. 6 shows yet another embodiment of a water distillation system 20 in accordance with the present disclosure. In this embodiment, the cooling apparatus 15, which comprises the conduit 17 and the condenser 23 (where further cooling can be effected if needed) includes a portion 73 of the conduit 17 that is formed in or partly in the water tank 47. This allows heat in the conduit 17 to be transferred in part to the water in the water tank 47. The cooling apparatus 15 also comprises a portion 75 of the conduit 17 that is formed outside the water tank 47 and downstream from the portion 73. Advantageously, transferring heat to the water present in the tank 47 pre-heats the water, which can allow for a more efficient water distillation process. If conduit portions 73 and 75 are adequate for condensing the water present in the conduit 17, then the condenser 73 is not required. A reservoir for collecting the distilled water can be placed at the output of conduit 17 or, when the condenser apparatus is present, at an output of the condenser apparatus.

In the embodiment of FIG. 6, the conduit 17 has a portion thereof that spans from the evaporator apparatus 21 to the water tank 47. However, this need not be the case; rather, the portion of the conduit 17 that spans from the evaporator apparatus 21 to the water tank 47 need not be present and the conduit 17 can run from the evaporator apparatus 21 immediately into the water tank 47.

As will be understood by the skilled worker, in the embodiments presented herein, the riser 30 and the air source 42 connected thereto (i.e. the air source 30 arranged to express air in the riser 30) can be said to form an airlift pump.

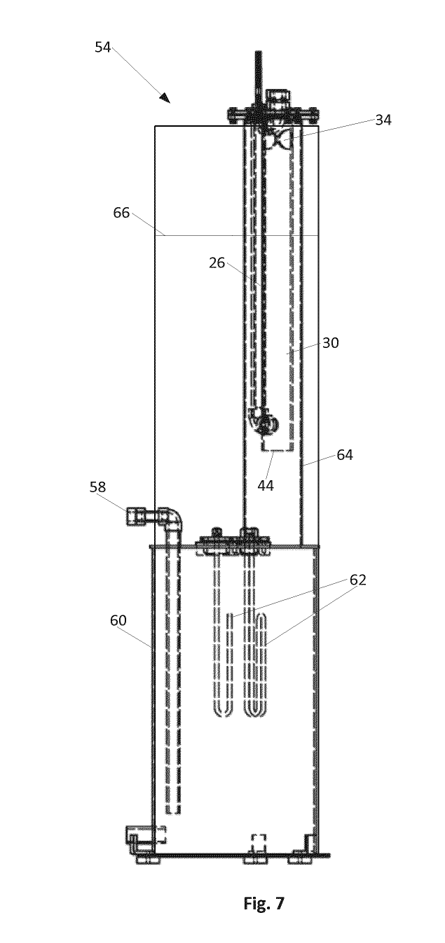

FIG. 7 shows a side elevation and cutaway view of components of another embodiment of an evaporator apparatus 54 in accordance with the present disclosure. The evaporator apparatus 54 receives water to be distilled at an inlet conduit 58. The water received at inlet conduit 58 enters a heating compartment 60 where it is heated by heating elements 62 (for example, electrical heating elements, natural gas heating elements, etc.). The heated water can flow up a pipe 64 toward the riser 30 and enter the riser 30 through the opening 44. Air travels through the heating chamber 26, where is it heated, and is provided to the riser 30.

Water can also flows out of the heating compartment 60 through apertures defined therein (not shown). The flow of water in the evaporator apparatus 54 can be controlled to have a level of water, in the evaporator apparatus 54, indicated by the waterline 66. The level of water in the evaporator apparatus 54 may vary and the evaporator apparatus 54 can be controlled (e.g., the heating elements 62 can be switched on or off) in accordance with the level of water through any suitable means.

As will be understood by the skilled worker, the distillation system embodiment of FIG. 1 can be adapted to include a heating device, such as heating device 51 of the embodiment of FIG. 4, into the water container 45 of FIG. 1. Further, the embodiments of FIGS. 1 and 6 can be adapted to include a water container overflow, such as the water container overflow 61 shown in the embodiment of FIG. 5. Furthermore, the embodiments of FIGS. 1, 4 and 5 can be adapted to include a cooling apparatus as shown in the embodiment of FIG. 6, i.e. a cooling apparatus that has a portion 73 of a conduit 17 partly formed in the water tank 47 and a portion 75 formed outside the water tank 47 and downstream from the portion 73.

In all the embodiments described herein, there can be included a distilled water reservoir to collect the distilled water produced by the distillation system of the present disclosure. Further, a heat exchanger can be configured to extract heat from the distilled water collected in the distilled water reservoir. Additionally, in the embodiments described herein, the air and/or gas used to form bubbles in the riser can be recovered and re-used.

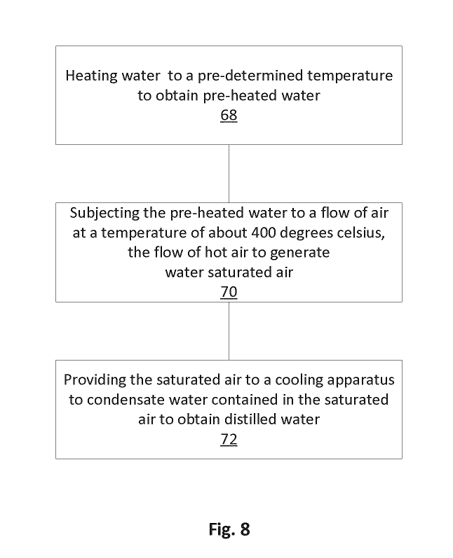

FIG. 8 shows a flowchart of a method of purifying water in accordance with an embodiment of the present disclosure. At action 68, water to be purified is heated to a pre-determined temperature to obtain pre-heated water, which can be any suitable temperature such as, for example, 100° C. As will be understood by the skilled worked, action 68 is optional. At action 70, the pre-heated water is subjected to a flow of hot air (this can occur in a riser such as the riser 30 show in previous figures). The hot air can be at any suitable temperature such as, for example, 400° C. This generates water saturated air, which can be at a temperature ranging from 200° C. to 500° C., or any other suitable temperature. At action 72, the water saturated air is provided to cooling apparatus where the water contained in the water saturated air is condensed and distilled water is obtained.

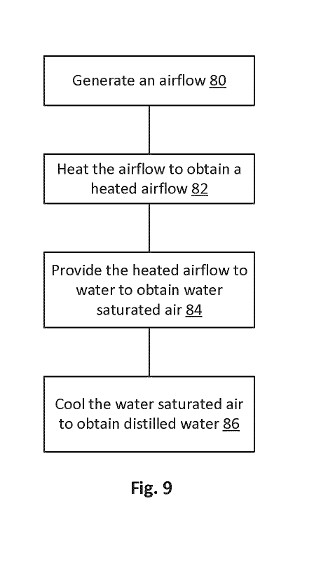

FIG. 9 shows a flowchart of a method of distilling water in accordance with another embodiment of the present disclosure. At action 80, an airflow is generated. At action 82, the airflow is heated to obtain a heated airflow. At action 84, the heated airflow is provided to produce water saturated air. At action 86, the water saturated air is cooled to cause condensation of the water present in the water saturated air and obtain distilled water.

Providing the heated airflow to the water can include providing the heated airflow at a bottom portion of a riser containing the water and the method can further comprise releasing the water saturated air at a top portion of the riser.

Cooling the water saturated air can include providing the water saturated air to a cooling apparatus and cooling the water saturated air to produce distilled water.

Cooling the water saturated air can include transferring heat from the water saturated air to a body of water to heat the body of water prior to the body of water being subjected to a distillation process.

The method can further comprise pre-heating the water prior to providing the heated airflow to the water.

Depending on the cleanliness of the water to be purified, the evaporator will require periodic purges to remove non-evaporable matter accumulation.

As will be understood by the skilled worker, the components of the distillation system of the present disclosure can be made of any suitable materials including, but not limited to, plastics and metals. As will also be understood by the skilled worker, the distillation system of the present disclosure can be run continuously or intermittently.

Advantageously, the present disclosure allows evaporating water with substantially less energy than required by simply boiling water through a conventional means.

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

1. A water distillation system comprising:
a heating chamber defining an air inlet configured to receive air in the heating chamber, the heating chamber further defining an air outlet configured to release air from the heating chamber;
a heater located in the heating chamber, the heater configured to heat the air propagating in the heating chamber from the air inlet to the air outlet, the air released by the air outlet being heated air; and
a riser defining a water input portion configured to receive water in the riser, the riser being configured to receive the heated air in a region of the riser configured to contain water, the heated air, when water is present in the riser, to produce air bubbles in the riser, the air bubbles to absorb water to obtain water saturated air bubbles, the water saturated air bubbles to rise in the riser and to exit the water present in the riser, the riser further defining a water saturated air output portion configured to receive the water saturated air and to propagate the water saturated air to an outside of the riser.

2. The system of claim 1, wherein:
the heating chamber is formed outside the riser,
the air outlet comprises an air conduit connected to the heating chamber and to the air input portion of the riser, and
the air conduit is configured to release the heated air into the riser.

3. The system of claim 1, wherein the heating chamber is formed at least partly within the riser.

4. The system of claim 3, wherein the air outlet includes a series of apertures configured to transmit the heated air from the heating chamber to any water present in the riser.

5. The system of claim 1, wherein system further comprises a pump configured for connection to the air inlet of the heating chamber, the pump to provide the air to the heating chamber.

6. The system of claim 1 further comprising a water container to receive the water to be distilled, wherein:
the heating chamber is located in the water container and
the water input portion of the riser is in fluid communication with the water container.

7. The system of claim 1 further comprising a heating device configured to heat any water present in the water container.

8. The system of claim 7 wherein the heating device is configured to heat the water in the water container to a temperature of up to the boiling temperature of water.

9. The system of claim 1, wherein the heater is configured to heat the air entering the air inlet to a temperature greater than 100° C.

10. The system of claim 1, wherein:
the system further comprises a cooling apparatus configured to receive the water saturated air from the water saturated air output portion of the riser and to cool the water saturated air,
the cooling apparatus is further configured to condense the water present in the water saturated air to produce distilled water.

11. The system of claim 6 further comprising a water tank connected to the water container, the water tank to supply the water to the water container.

12. The system of claim 11 wherein, the cooling apparatus has a water saturated air conduit formed at least partly in the water tank, the water saturated air conduit being configured to transfer heat from the water saturated air present in the water saturated air conduit to the water present in the water tank.

13. The system of claim 12, wherein:
the water saturated air conduit is also partly formed outside the water tank, and
a portion of the water saturated air conduit formed outside the water tank is downstream from a portion of the water saturated air conduit formed in the water tank.

14. The system of claim 1 further comprising an overflow conduit in fluid communication with the water container, the overflow conduit being configured to release water from the water container when a water level in the water container exceeds a pre-determined water level.

15. (canceled)

16. (canceled)

17. (canceled)

18. (canceled)

19. (canceled)

20. A water distillation system comprising:
a vessel configured to hold water;
an airlift pump having an air source and a riser tube, the riser tube having a water intake portion configured to be disposed in the vessel and immersed in water when the water distillation system is in operation, the air source configured to provide an airflow to the riser tube at a portion of the riser tube immersed in water when the water distillation system is in operation; and
a heater configured to heat the airflow to obtain a heated airflow, the heater to heat the airflow prior to the airflow being provided to the riser tube, the heated airflow to heat the water to produce water saturated air, the riser tube further defining a water saturated air output portion configured to receive the water saturated air and to propagate the water saturated air to an outside of the riser.

21. The system of claim 20 further comprising a heating chamber to house the heater, the heating chamber defining an air inlet configured to receive air in the heating chamber, the heating chamber further defining an air outlet configured to release air from the heating chamber, wherein:
the heating chamber is formed outside the riser tube,
the air outlet comprises an air conduit connected to the heating chamber and to the air input portion of the riser, and
the air conduit is configured to release the heated air into the riser tube.

22. The system of claim 20, wherein the heating chamber is formed at least partly within the riser.

23. The system of claim 20, wherein the air outlet includes a series of apertures configured to transmit the heated air from the heating chamber to any water present in the riser tube.

24. The system of claim 20, wherein the system further comprises a pump configured for connection to the air inlet of the heating chamber, the pump to provide the air to the heating chamber.

25. The system of claim 20 further comprising a water container to receive the water to be distilled, wherein:
the heating chamber is located in the water container and
the water input portion of the riser is in fluid communication with the water container.

26. (canceled)

27. (canceled)

28. (canceled)

29. (canceled)

30. (canceled)

31. (canceled)

32. (canceled)

33. (canceled)
